(19) United States
(12) Patent Application Publication
(10) Pub. No.: US 2006/0160516 A1
(43) Pub. Date: Jul. 20, 2006

(54) Pulse shaping optimizer in UWB receiver

(76) Inventors: Dongsong Zeng, Germantown, MD (US); Amir Zaghloul, Bethesda, MD (US); Annamalai Annamalai, Christiansburg, VA (US)

Correspondence Address: HONEYWELL INTERNATIONAL INC., 101 COLUMBIA ROAD, P O BOX 2245, MORRISTOWN, NJ, 07962-2245, US

(21) Appl. No.: 11/331,922

(22) Filed: Jan. 13, 2006

Related U.S. Application Data
(60) Provisional application No. 60/644,301, filed on Jan. 14, 2005.

(51) Int. Cl. H04B 1/18

(52) U.S. Cl. 455/293

(57) ABSTRACT

A receiver for receiving a signal is provided. The receiver comprises a pulse shaper that shapes a received signal using a transfer function, the pulse shaper being adapted to determine a set of coefficients for the transfer function based on the received signal. The receiver also comprises a mixer that mixes the shaped signal with a generated template to create a mixed signal, and an integrator that integrates the mixed signal to generate an integrated signal.

### RELATED APPLICATIONS

This application claims the priority of U.S. Provisional Application No. 60/644,301, filed Jan. 14, 2005, which is included herein in its entirety by reference.

### BACKGROUND

Ultra WideBand (UWB) radio is a promising technology for high-speed short range communications such as wireless Local Area Network (LAN). Currently, two kinds of detection techniques have been used in UWB receivers, i.e., coherent detection and transmitted reference detection. Coherent detection receivers typically require less signal power to achieve a given bit

error rate than non-coherent receivers using transmitted reference detection. However, coherent receivers need to generate a template waveform locally to match a received signal. Generating a template which exactly matches the received signal is usually difficult and costly. In order to lessen the cost and difficulty, a simplified template generator is usually used. Since the simplified template does not exactly match the received signal, the receiver performance is degraded.

On the other hand, transmitted reference detection (also known as differential detection and self-correlation) uses a delayed received signal to correlate the current signal. Therefore, receivers using transmitted reference detection don't need to generate a template signal locally. However, the use of a potentially noisy signal as a reference signal makes transmitted reference detection a less desirable alternative to coherent detection. Additionally, if the propagation channel is time-varying, the differential receiver performance will degrade due to inter-symbol interference (ISI). In theory, an adaptive differential receiver may mitigate this time-varying issue by a decision feedback technique, but in practice, this adaptive method works well only when the signal-to-noise ratio is high. When the signal-to-noise ratio is relatively low, the decision feedback method may deteriorate the system performance. Therefore, transmitted reference detection is not an optimal alternative to the power benefits of coherent detection.

For the reasons stated above, and for other reasons stated below which will become apparent to those skilled in the art upon reading and understanding the present specification, there is a need in the art for a system and method of mitigating the performance degradation of an unmatched template in coherent UWB receivers.

### SUMMARY

The above-mentioned problems and other problems are resolved by the present invention and will be understood by reading and studying the following specification.

In one embodiment, a receiver for receiving a signal is provided. The receiver comprises a pulse shaper that shapes a received signal using a transfer function, the pulse shaper being adapted to determine a set of coefficients for the transfer function based on the received signal. The receiver also comprises a mixer that mixes the shaped signal with a generated template to create a mixed signal, and an integrator that integrates the mixed signal to generate an integrated signal.

In another embodiment a method of improving performance of a receiver is provided. The method comprises receiving a signal, determining coefficients for a transfer function based on the received signal, shaping the signal using the transfer function in order to generate a shaped signal, receiving a template signal, mixing the shaped signal and the template signal to generate a mixed signal, and integrating the mixed signal to generate an integrated signal.

In another embodiment, a communications system is provided. The communications system comprises a transmitter adapted to transmit a modulated signal generated using a pulse-based modulation scheme, and a receiver adapted to receive and shape the transmitted signal using a transfer function having coefficients based on the received signal and determined from a genetic algorithm.

In another embodiment, a receiver for receiving a signal is provided. The receiver comprises means for receiving a pulse-based modulated signal, means for performing a genetic algorithm to generate coefficients of a transfer function based on the received signal, means for shaping the received signal using the transfer function in order to generate a shaped signal, means for mixing the shaped signal and a template signal to generate a mixed signal, and means for integrating the mixed signal to generate an integrated signal.

### DRAWINGS

FIG. 1 is a graph showing the shape of various filtered ultra wideband pulses.

FIG. 2 is a flow chart showing a method of improving performance of a receiver using a pulse shaper according to one embodiment of the present invention.

FIG. 3 a flow chart showing a method of determining filter coefficients using a genetic algorithm according to one embodiment of the present invention.

FIG. 4 is a graph of an exemplary objective function having multiple maxima.

FIG. 5 is a block diagram of an ultra wideband communications system utilizing a pulse shaper in a receiver according to one embodiment of the present invention.

FIG. 6(a) is a simplified block diagram of a pulse shaper according to one embodiment of the present invention.

FIG. 6(b) is another simplified block diagram of a pulse shaper according to one embodiment of the present invention.

Like reference numbers and designations in the various drawings indicate like elements.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. It should be understood that the exemplary method illustrated may include additional or fewer steps or may be performed in the context of a larger processing scheme. Furthermore, the methods presented in the drawing figures or the specification are not to be construed as limiting the order in which the individual steps may be performed. The following detailed description is, therefore, not to be taken in a limiting sense.

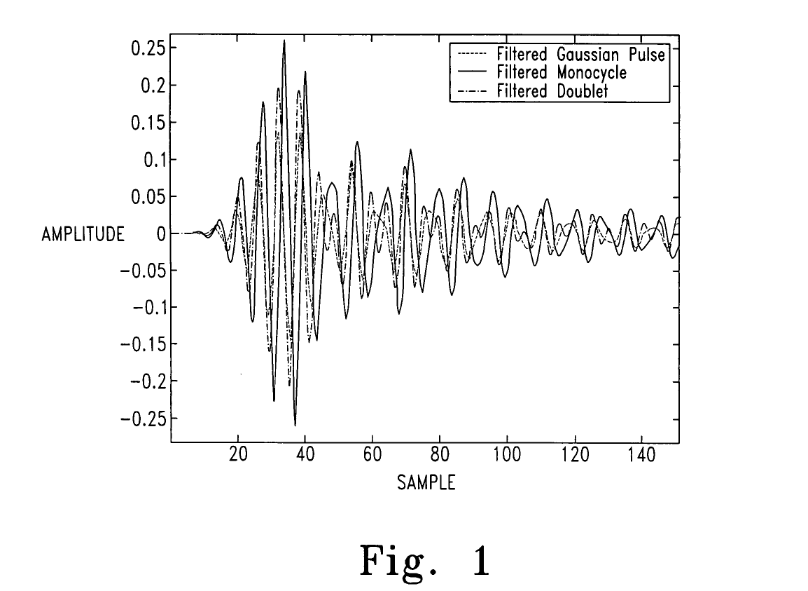

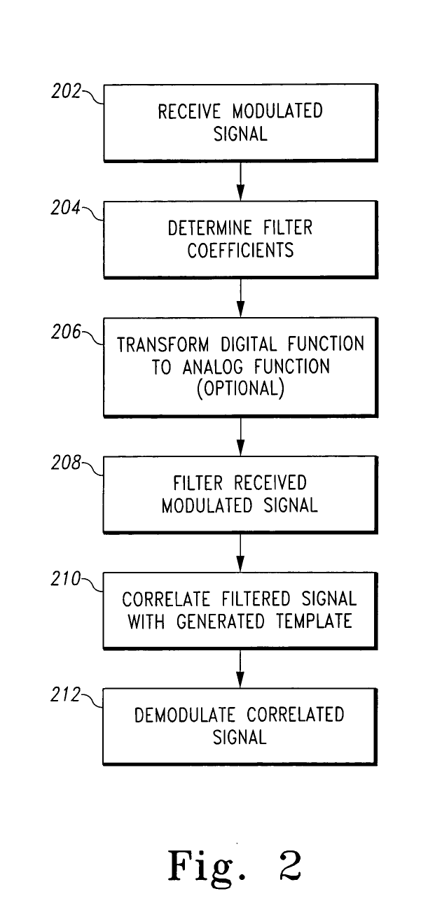

The Federal Communications Commission (FCC) allows ultra wideband (UWB) signals to use a frequency band of 3.1 GHz to 10.6 GHz. “Notice of Inquiry in the Matter of Revision of part 15 of the Commission's Rules Regarding Ultra-Wideband Transmission Systems”, FCC Docket Number (No.) 98-208/ET No. 98-153. Therefore, all UWB signals typically go through a band-pass filter before being transmitted in order to reduce interference with other existing communications systems. The shape of various UWB signals after passing through a filter with band-pass from 3.1 GHz to 10.6 GHz, are all similar regardless of the pulse shape prior to being filtered. For example, a Gaussian pulse, monocycle, and doublet wave form all have a similar shape after being filtered, as shown in FIG. 1. Additionally, as shown in FIG. 2, the signals tend to spread out over time. As the signals spread, the signal magnitude envelope tapers and the signal wave forms tend to be irregular making it difficult to exactly match a received signal with a generated template. A simple generalized template is typically used in a correlation receiver as an approximation of the received signal wave form. Embodiments of the present invention improve the signal-to-noise ratio (SNR) of the receiver output signal and, thus, reduce the performance degradation for any arbitrary generalized template. For example, as can be seen in FIG. 1, the energy concentrated area has a pulse shape similar to a sinusoidal wave form. Therefore, some researchers propose using a generalized sinusoidal wave which is easy to generate. S. Lee, “Design and Analysis of Ultra-wide Bandwidth Impulse Radio Receiver,” Ph.D. thesis, electrical engineering department, University of Southern California, 2002. Additionally, since the energy of the transmitted pulse is spread out in the time domain at the receiver, in some embodiments, a longer template is used to collect more signal energy. Embodiments of the present invention improve the output signal (SNR) of receivers using wave form templates, such as sinusoidal and other generalized wave form templates.

FIG. 2 is a flow chart showing a method 200 of improving performance of a receiver using a pulse shaper according to one embodiment of the present invention. At 202, a modulated signal is received by a correlation receiver. The modulated signal is generated using a pulse-based modulation scheme, such as a pulse-position modulation or a pulse-amplitude modulation scheme. The received signal can be expressed by the equation x(t)=w(t)+n(t), wherein w(t) represents the noise-free signal wave form and n(t) is the received thermal noise. The thermal noise has a single-side noise density Nₒ. The thermal noise density, Nₒ, is a product of the Boltzmann constant, k, and the absolute environment temperature, T, in Kelvin.

At 204, coefficients are determined for a transfer function of a pulse shaper based on the received signal. In some embodiments, the pulse shaper is an all-pass filter with a transfer function, H(z), used to improve the correlation receiver output SNR. In some embodiments, the coefficients of the pulse shaper are determined digitally. In some such embodiments, the digital form of the pulse shaper is given as

$$H ( z ) = {\prod }_{j = 1}^{M} \frac{{c}_{2 j} + {c}_{1 j} {z}^{- 1} + {z}^{- 2}}{1 + {c}_{1 j} {z}^{- 2} + {c}_{2 j} {z}^{- 2}} .$$

In some such embodiments, only one second-order-section (SOS) is used, i.e. M=1 in the filter equation

$$H ( z ) = {\prod }_{j = 1}^{M} \frac{{c}_{2 j} + {c}_{1 j} {z}^{- 1} + {z}^{- 2}}{1 + {c}_{1 j} {z}^{- 2} + {c}_{2 j} {z}^{- 2}} .$$

Hence, the filter equation becomes

$${H}_{p} ( z ) = \frac{{c}_{2} + {c}_{1} {z}^{- 1} + {z}^{- 2}}{1 + {c}_{1} {z}^{- 2} + {c}_{2} {z}^{- 2}} .$$

For purposes of explanation a pulse shaper with one SOS is described herein. However, it will be understood by one of skill in the art that, in other embodiments, N SOSs are used. For example, in some embodiments, two SOSs are used. In order to make the filter stable, the filter coefficients must satisfy the constraints: c₂ⱼ<1,c₁ⱼ−cₒⱼ<1, and c₁ⱼ−c₂ⱼ>−1. In addition, the coefficients are chosen to substantially maximize the receiver output SNR. The objective function to be substantially maximized is based on the received signal.

The output of the pulse shaper is expressed as z(t)=u(t)+n₁(t), wherein u(t) is the filtered signal of w(t) and n₁(t) is the filtered noise. The filtered signal, u(t), is expressed as

$$u ( t ) = {\int }_{0}^{t} w ( τ ) h ( τ - t ) ⅆ τ .$$

The filtered noise, n₁(t), is expressed as

$${n}_{1} ( t ) = {\int }_{0}^{t} n ( t ) h ( τ - t ) ⅆ τ .$$

In the previous equations, τ denotes the time offset of a template relative to the received signal pulse. Hence, the correlation, Rᵤᵥ(τ), of the filtered signal, u(t), and a receiver template, v(t), is expressed as

$${R}_{uv} ( τ ) = {\int }_{0}^{Δ t} u ( t ) \cdot v ( t - τ ) ⅆ t ,$$

wherein Δt denotes the template duration. The auto-correlation of the template itself is expressed as

$${R}_{vv} ( τ ) = {\int }_{0}^{Δ t} v ( t ) \cdot v ( t - τ ) ⅆ t .$$

Also, the total noise power, N, can be expressed as

$$N = \frac{1}{2} {N}_{0} {R}_{vv} ( 0 ) .$$

Therefore, the SNR of the receiver output signal is

$$SNR = \frac{2}{{N}_{0}} \cdot \frac{{R}_{uv}^{2} ( τ )}{{R}_{vv} ( 0 )} .$$

Under ideal conditions, the time offset, τ, is zero and the template is the same as the noise-free received pulse. In such conditions, the SNR is maximal. J. B. Thomas, An introduction to statistical communication theory, John Wiley & Sons, Inc., New York, 1968. If the time offset, τ, is not zero, the template is not the same as the noise-free incoming pulse. In such conditions the SNR will degrade. Therefore, at 204, filter coefficients for a pulse shaper are chosen to substantially maximize the equation

$$SNR = \frac{2}{{N}_{0}} \cdot \frac{{R}_{uv}^{2} ( τ )}{{R}_{vv} ( 0 )} ,$$

mitigating the SNR degradation.

Additionally, since Rᵥᵥ (0) is constant for an arbitrary receiver template, v(t), and if perfect synchronization is assumed (i.e. τ=0), substantially maximizing

$$SNR = \frac{2}{{N}_{0}} \cdot \frac{{R}_{uv}^{2} ( τ )}{{R}_{vv} ( 0 )}$$

is equivalent to substantially maximizing

$${R}_{uv} ( 0 ) = {\int }_{0}^{Δ t} ( {\int }_{0}^{t} w ( τ ) h ( τ - t ) ⅆ τ ) v ( t ) ⅆ t .$$

Hence, the coefficients of the transfer function are based on the received signal, w(τ).
In some embodiments, a genetic algorithm is used to determine coefficients that will satisfy the constraints and substantially maximize

$${R}_{uv} ( 0 ) = {\int }_{0}^{Δ t} ( {\int }_{0}^{t} w ( τ ) h ( τ - t ) ⅆ τ ) v ( t ) ⅆ t .$$

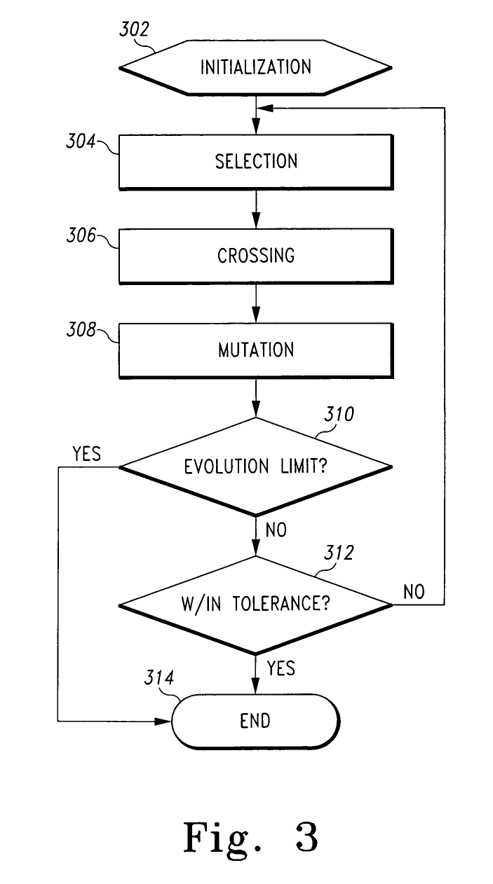

A genetic algorithm is described below in more detail with regards to FIG. 3. In other embodiments, other methods known to one of skill in the art, such as using gradients and using higher derivatives, are used to determine filter coefficients. By choosing coefficients which substantially maximize

$${R}_{uv} ( 0 ) = {\int }_{0}^{Δ t} ( {\int }_{0}^{t} w ( τ ) h ( τ - t ) ⅆ τ ) v ( t ) ⅆ t ,$$

the pulse shaper shapes the received signal pulse such that the output SNR after correlating the received signal with a receiver template is improved. In some embodiments, the filter coefficients are dynamically updated. In other embodiments, the filter coefficients are updated when a pre-determined condition is met. In other embodiments, the filter coefficients do not change after an initial determination of coefficients.

At 206, in some embodiments when the coefficients are determined digitally, the digital transfer function is transformed to an analog transfer function. In some such embodiments, this is accomplished by using one of a bilinear transform and a Pade polynomial approximation. In embodiments using a Pade polynomial, the analog filter phase response is closer to the digital filter phase response as the order of the Pade polynomial increases.

At 208, the received modulated signal is filtered with the pulse shaper using the transfer function coefficients determined at 204 to generate a shaped signal. The shaped signal is then correlated with a generated receiver template at 210. Correlation of the shaped signal with the receiver template includes, in some embodiments, mixing the shaped signal with the template to generate a mixed signal and integrating the mixed signal. In some embodiments, the template is a sinusoidal waveform. In other embodiments, other waveforms are used. At 212, the output of a correlation receiver is demodulated. Demodulation of the correlated signal extracts at least a portion of the data modulated onto the transmitted signal that is received at 202.

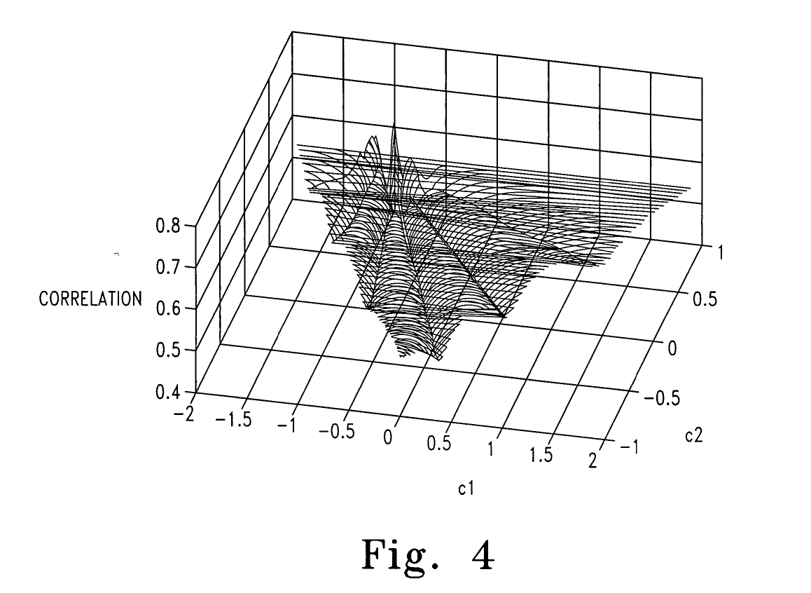

FIG. 3 is a flow chart showing a method 300 of determining filter coefficients using a genetic algorithm according to one embodiment of the present invention. Genetic algorithms are known to one of skill in the art. Rather than searching from point to point for maxima of an objective function, genetic algorithms move from a group of points (i.e. genes) to a new group of points through evolution, in which the genes with better objective values are more likely to be inherited. B. Liu, Uncertain Programming, John Wiley & Sons, New York, 1999 and J. R. Koza, “Genetic Programming,” MIT Press, Cambridge, 1994. As can be seen in the exemplary graph in FIG. 4, the objective function, Rᵤᵥ(0), has multiple maxima, in some embodiments. Therefore, a genetic algorithm is well suited to find a global maximum and not get trapped in local maxima as can happen with other methods, such as using gradients and using higher derivatives.

At 302, the genetic algorithm is initialized. At initialization, a group of N input argument vectors, Vᵢ, i=1 . . . N, are randomly selected such that they all satisfy the coefficient constraints. For a second-order-section (SOS) filter, the i-th argument vector, Vᵢ, equals [c₁, c₂]. At 304, a selection process orders genes (i.e. argument vectors) from maximum to minimum according to their objective function values. The selection process then evaluates each gene using an evaluation equation given as

$${q}_{i} = eval ( {V}_{i} ) = {\sum }_{j = 1}^{i} alpha * {( 1 - alpha )}^{j - 1} , for i = 1 , 2 , … N .$$

The notation alpha is any number between zero and one. In one embodiment, alpha is set to 0.1. The selection process then generates a random number in the range of [0,q_{N}]. If the random number is between qᵢ and qⱼ, then Vⱼ is selected to form a new gene. By repeating this step N times, a new group of N genes is created.

At 306, a crossing process begins. The crossing process arbitrarily selects a probability of crossing, P_{c}. For example, in some embodiments, P_{c} is set to 0.2. In other embodiments, P_{c} is set to other values. N random numbers, rᵢ, in the range of [0,1] are then generated. If rᵢ is less than P_{c}, then Vᵢ is selected for crossing. Once the genes have been selected for crossing, the selected genes are randomly paired up. If the number of the selected genes is odd, one gene is simply ignored. If the pair of selected genes are Vᵢ and Vⱼ, after crossing the new genes Vᵢ′ and Vⱼ′ are created. Vᵢ′ and Vⱼ′ are expressed as Vᵢ′=g*Vᵢ+(1−g)Vⱼ and Vⱼ′=(1−g)*Vᵢ+gV_{j,} respectively. The notation g is a random number between 0 and 1. The new genes must satisfy all the original constraints. If the new genes do not satisfy the original constraints, random number g is regenerated until the new genes are inside the constrained area. After all the pairs of genes are crossed, the crossing process is finished.

At 308, a mutation process begins. In the mutation process, a probability of mutation, Pₘ, is decided. In some embodiments, Pₘ is set to 0.8. In other embodiments, other initial values are used for Pₘ. N random numbers, rᵢ, are generated. If rᵢ is not greater than Pₘ, then Vᵢ is updated using the equation Vᵢ=Vᵢ+M*d. M is a randomly generated step length and d is a randomly selected direction. Selection of M and d must make Vᵢ satisfy the constraints. Upon completion of the mutation process one evolution cycle is completed.

At 310, it is determined if the number limit of evolution cycles has been reached. If the limit has been reached the genetic algorithm ends at 314. If the limit has not been reached, it is determined at 312 if the values obtained from the genetic algorithm are within a selected range of tolerance. If the values are not within the range of tolerance another evolution cycle begins at 304. If the values are within the range of tolerance, the genetic algorithm ends at 314.

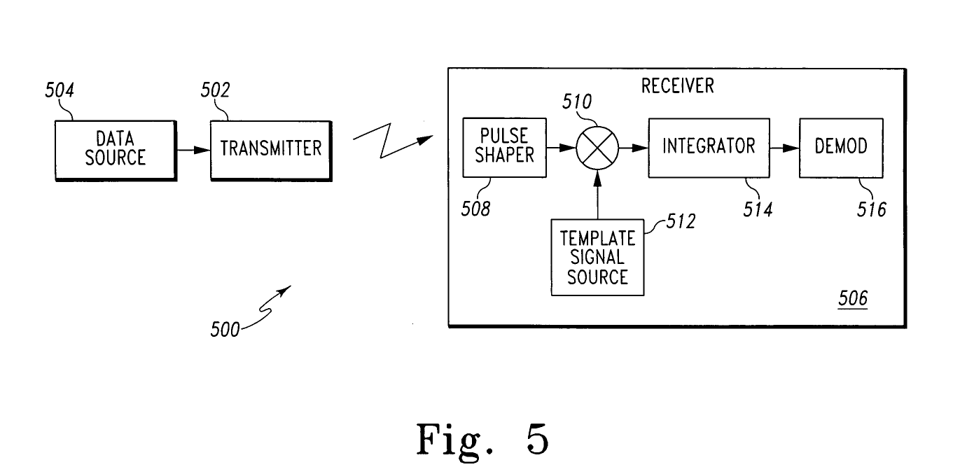

FIG. 5 is a block diagram of an ultra wideband communications system 500 utilizing pulse shaper 508 in receiver 506 according to one embodiment of the present invention. Although a particular embodiment of pulse shaper 508 for use in an ultra wideband receiver 506 is described herein, it is to be understood that pulse shaper 508 is suitable for use in other embodiments and can be implemented in other ways. Embodiments of pulse shaper 508 described herein are suitable for use in a wide range of systems and devices that make use of a pulse-based modulation scheme (for example, a pulse-position modulation scheme or a pulse-amplitude modulation scheme).

The communications system 500 comprises transmitter 502 that receives data from data source 504 and modulates the received data in order to generate a modulated signal that is transmitted by transmitter 502. Transmitter 502 modulates the data using a pulse-based modulation scheme, such as a pulse-position modulation scheme or a pulse-amplitude modulation scheme, in order to generate the modulated signal. In the particular embodiment shown in FIG. 2, transmitter 502 transmits the modulated signal over a wireless communication link, such as a radio frequency wireless link. In other embodiments, transmitter 502 transmits the transmitted signal over other types of communication links including, but not limited to, copper wires, coaxial cable, and optical fibers.

The system 500 further comprises receiver 506 that receives the transmitted modulated signal. Receiver 506 comprises pulse shaper 508 that outputs a shaped signal based on the received modulated signal, mixer 510 that mixes the shaped signal with a template signal to generate a mixed signal, and integrator 514 that integrates the mixed signal to generate an integrated signal. The template signal is provided by template signal source 512. The integrated signal is used by demodulator 516 to extract at least a portion of the data modulated onto the transmitted modulated signal that is received by receiver 506.

Pulse shaper 508 comprises, in some embodiments, an all-pass filter having a transfer function derived using a genetic algorithm, as described above. For example, in some such embodiments, the all-pass filter comprises a set of filter coefficients that are calculated using the genetic algorithm. In some embodiments, the transfer function of pulse shaper 508 is dynamically updated based on the genetic algorithm. For example, in some such embodiments, the genetic algorithm described above (or a portion thereof) is performed periodically in order to update or further refine the transfer function. In other embodiments, the transfer function is dynamically updated using the genetic algorithm in other ways (for example, updating the transfer function when a pre-determined condition is met, such as the performance of receiver 508 falling below some performance threshold). In other embodiments, the transfer function of pulse shaper 508 is static. That is, the genetic algorithm described above is used to generate an initial transfer function for pulse shaper 508 that is thereafter used by pulse shaper 508 without further refinement or updating.

In some embodiments, transmitter 502 comprises an ultra wideband transmitter and receiver 506 comprises an ultra wideband receiver. Transmitter 502 and receiver 506 include other components that, for the sake of clarity, are not shown in FIG. 5. For example, other components in transmitter 502 and receiver 506 not shown in FIG. 5 include one or more of antennas, filters, and amplifiers.

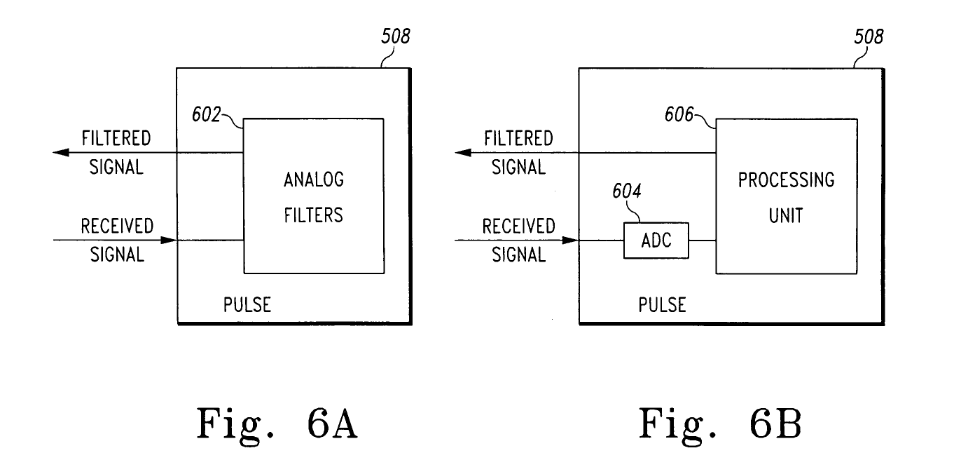

In some embodiments, as shown in FIG. 6(a), pulse shaper 508 includes, analog filters 602 whose coefficients are determined by the method discussed above. In other embodiments, as shown in FIG. 6(b), pulse shaper 508 includes analog-to-digital converter (ADC) 604 for converting analog signals to digital signals and processing unit 606. In some embodiments, processing unit 606 is implemented as an application specific integrated circuit for performing methods and techniques of filtering a received signal as described above. In other embodiments, processing unit 606 is implemented as a field programmable gate array adapted to perform methods and techniques of filtering a received signal as described above. In yet other embodiments, processing unit 606 is implemented as a general purpose programmable processor, such as a computer.

Processing unit 606 includes or interfaces with hardware components and circuitry that support the filtering of a received signal as described above. By way of example and not by way of limitation, these hardware components include one or more microprocessors, memories, storage devices, interface cards, and other standard components known in the art. Additionally, processing unit 606 includes or functions with software programs, firmware or computer readable instructions for carrying out various methods, process tasks, calculations, control functions, used in the filtering of a received signal as described above. The computer readable instructions, firmware and software programs are tangibly embodied on any appropriate medium used for storage of computer readable instructions including, but not limited to, all forms of non-volatile memory, including, by way of example and not by limitation, semiconductor memory devices, such as EPROM, EEPROM, and flash memory devices; magnetic disks such as internal hard disks and removable disks; magneto-optical disks; and DVD disks. As stated above, any of the foregoing may be supplemented by, or incorporated in, specially-designed application-specific integrated circuits (ASICs) and field programmable gate arrays (FPGAs).

For example, in some embodiments, the genetic algorithm described herein is implemented, at least partially, in software by programming one or more programmable processors to carry out the processing of the genetic algorithm. The software comprises program instructions that are embodied on a medium from which the program instructions are read by a programmable processor in connection with execution of the program instructions by the programmable processor.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A receiver for receiving a signal comprising:
a pulse shaper that shapes a received signal using a transfer function, the pulse shaper being adapted to determine a set of coefficients for the transfer function based on the received signal;
a mixer that mixes the shaped signal with a generated template to create a mixed signal; and
an integrator that integrates the mixed signal to generate an integrated signal.

2. The receiver of claim 1, further comprising:
a demodulator adapted to extract at least a portion of modulated data from the integrated signal.

3. The receiver of claim 1, wherein the receiver comprises an ultra wideband receiver.

4. The receiver of claim 1, wherein the pulse shaper comprises an all-pass filter.

5. The receiver of claim 1, wherein the pulse shaper comprises:
at least one processor adapted to perform instructions containing methods for shaping the received signal with a transfer function having coefficients determined by a genetic algorithm.

6. The receiver of claim 1, wherein the pulse shaper comprises of one of a field programmable gate array and an application specific integrated circuit.

7. The receiver of claim 1, wherein the pulse shaper is adapted to determine the set of coefficients for the transfer function using a genetic algorithm.

8. The receiver of claim 1, wherein the pulse shaper periodically updates the coefficients of the transfer function based on the received signal.

9. A method of improving performance of a receiver, the method comprising:
receiving a signal;
determining coefficients for a transfer function based on the received signal;
shaping the signal using the transfer function in order to generate a shaped signal; and
correlating the shaped signal with a template signal.

10. The method of claim 9, further comprising:
demodulating the correlated signal to extract at least a portion of modulated data on the received signal.

11. The method of claim 9, further comprising one or more of:
periodically updating transfer function coefficients; and
updating transfer function coefficients when a pre-determined condition is met.

12. The method of claim 9, wherein determining coefficients for a transfer function further comprises:
using a genetic algorithm to determine transfer function coefficients.

13. The method of claim 12, wherein using a genetic algorithm further comprises:
initializing the genetic algorithm by randomly selecting N input argument vectors that all satisfy coefficient constraints; and
performing one or more of a selection process, a crossing process and a mutation process.

14. The method of claim 13, further comprising one or more of:
ending the genetic algorithm when it is determined that an evolution cycle limit is reached; and
ending the genetic algorithm when it is determined that values obtained from the genetic algorithm are within a selected range of tolerance.

15. The method of claim 9, wherein determining coefficients for a transfer function further comprises:
digitally determining coefficients for a transfer function.

16. The method of claim 15, further comprising:
transforming the digital transfer function to an analog transfer function.

17. The method of claim 16, wherein transforming the digital transfer function further comprises using one of a bilinear transform and a Pade polynomial approximation.

18. A communications system comprising:
a transmitter adapted to transmit a modulated signal generated using a pulse-based modulation scheme; and
a receiver adapted to receive and shape the transmitted signal using a transfer function having coefficients based on the received signal and determined from a genetic algorithm.

19. The communications system of claim 18, wherein the transmitter comprises an ultra wideband transmitter and the receiver comprises an ultra wideband receiver.

20. The communications system of claim 18, wherein the receiver further comprises:
a pulse shaper adapted to shape the received signal using the transfer function;
a mixer adapted to mix the shaped signal with a template signal; and
an integrator adapted to integrate the mixed signal.

21. The communications system of claim 20, wherein the receiver further comprises:
a template signal source adapted to generate a template to be mixed with the received signal.

22. The communications system of claim 20, wherein the receiver further comprises:
a demodulator adapted to extract at least a portion of modulated data from the integrated signal.

23. The communications system of claim 20, wherein the pulse shaper comprises an all-pass filter.

24. A receiver for receiving a signal comprising:
means for receiving a pulse-based modulated signal;
means for performing a genetic algorithm to generate coefficients of a transfer function based on the received signal;
means for shaping the received signal using the transfer function in order to generate a shaped signal;
means for mixing the shaped signal and a template signal to generate a mixed signal; and
means for integrating the mixed signal to generate an integrated signal.

25. The receiver of claim 24, further comprising:
means for demodulating the integrated signal to extract at least a portion of modulated data on the integrated signal.

26. The receive of claim 24, further comprising:
means for generating a template signal to be mixed with the received signal.
